(19) United States
(12) Patent Application Publication
(10) Pub. No.: US 2011/0115183 A1
(43) Pub. Date: May 19, 2011

(54) CROSS-MEMBER FOR A REAR TWIST-BEAM AXLE SUSPENSION FOR A MOTOR-VEHICLE AND METHOD FOR ITS PRODUCTION

(76) Inventors: Guido Sebastiano Alesso, Savigliano (Cuneo) (IT); Massimo Trinchera, Torino (IT); Lorenzo Castagno, Torino (IT); Andrea Santini, Collegno (Torino) (IT); Piero Monchiero, Torino (IT)

(21) Appl. No.: 13/002,841

(22) PCT Filed: Dec. 4, 2008
(86) PCT No.: PCT/IB2008/055103

§ 371 Date: Jan. 6, 2011

(30) Foreign Application Priority Data
Jul. 8, 2008 (IT) TO2008A00521

(51) Int. Cl. B60G 21/055; B21D 53/88

(52) U.S. Cl. 280/124.106; 29/897.2

(57) ABSTRACT

A cross-member for a motor-vehicle twist-beam axle suspension includes a single piece of steel that defines a closed cross-section and integrally forms a middle section, a pair of end sections, and a pair of joining sections. The middle section has a center axis extending along a curvilinear path lying in a first plane and a squashed portion extending in a second plane inclined to the first plane. The end sections are adapted to be securely connected to respective trailing arms of the twist-beam axle suspension. Each of the joining sections is interposed between the middle section and the respective end section and defines an opposite concavity with respect to the middle section. A twist-beam axle suspension for a motor vehicle includes the cross-member and a pair of trailing arms. A method produces the cross-member for a motor-vehicle twist-beam axle suspension.

### CROSS-REFERENCE TO RELATED APPLICATIONS

This application claims priority to and benefit of the filing date of PCT Patent Application PCT/IB2008/055103 entitled “CROSS-MEMBER FOR A REAR TWIST-BEAM AXLE SUSPENSION FOR A MOTOR VEHICLE AND METHOD FOR ITS PRODUCTION” and filed on Dec. 4, 2008, which claims priority to and benefit of the filing date of Italian Patent Application TO2008A000521 filed on Jul. 8, 2008.

### BACKGROUND OF INVENTION

1. Field of Invention

The present invention relates to a cross-member for a twist-beam axle suspension for a motor vehicle, particularly for a rear suspension, as well as to method for its production.

2. Description of Related Art

Rear twist-beam axle suspensions for motor vehicles are known which comprise a central cross-member and a pair of trailing arms which are rigidly connected to the opposite transverse ends of the cross-member and carry at their rear ends respective members for support of the wheel axles and at their front ends respective members for attachment to the vehicle body. While the trailing arms can be considered as rigid components, in that they are subject to negligible deformations in normal load conditions, the cross-member must have, on the other hand, a certain compliance, particularly under torsion, to allow the trailing arms to rotate elastically with respect to one another.

Since the length of the cross-member is basically imposed by the specific application, as it is linked to the vehicle's tread, the torsional stiffness of the cross-member can be changed to take a given design value by properly shaping the cross-section of the cross-member, particularly the cross-section in the middle plane. In this connection, the cross-members currently used in the twist-beam axle suspensions for motor vehicles can be classified into two distinct categories. On the one hand, there are open-section cross-members consisting of a sheet-metal beam which is generally obtained by stamping or other plastic deformation process and has a cross-section with an outline of a variety of shapes, for instance of C-, U-, V- or Ω-like shape. On the other hand, there are closed-section cross-members consisting of a metal tubular beam which is plastically deformed, for instance by stamping or hydroforming process, so that its cross-section is given a predetermined shape such as to provide the beam with the desired torsional stiffness characteristics. In particular, the most important characteristic of the cross-section of the cross-member is the vertical position of the shear centre, as it directly and heavily affects the toe change of the suspension under roll, which is one the most important parameters for the assessment of the performance of the suspension in terms of handling. Cross-members with middle cross-sections having the same vertical size but different shapes and orientations have shear centres located at different heights and therefore affect the kinematic and elasto-kinematic performances of the suspension in different ways.

Irrespective of the shape of the cross-section, the cross-members currently used in the twist-beam axle suspensions for motor vehicles extend generally horizontally, i.e., their axes lie in substantially horizontal planes. Such a conformation of the cross-member causes problems of space availability when the wheels carried by the trailing arms of the twist-beam axle are driving wheels. It is the case for instance of a rear twist-beam axle suspension for a four- or rear-wheel drive motor vehicle. The problems of space availability are basically due to the presence of the drive shaft which extends longitudinally, i.e., perpendicularly to the cross-member, thereby “crossing” the cross-member itself.

In order to allow the use of a twist-beam axle suspension for the rear wheels of a four-wheel drive motor vehicle, a cross-member is known from European Patent application EP-A-0 733 501 which is bowed or arched at least in a middle portion thereof. By virtue of the fact that the middle portion of the cross-member extends upwards, the drive shaft intended to drive the rear wheels can pass underneath the middle portion without interfering with it. The cross-member may be arched throughout its width or may have only an arched middle portion which smoothly joins with respective straight end portions. The end portions of the cross-member, whether arched or straight, are inclined to the horizontal. Since the trailing arms extend on the other hand horizontally, the welded joints between the ends of the cross-member and the trailing arms have therefore a rather irregular and complex shape which leads to an irregular stress distribution with peak values which may cause structural problems.

Moreover, the cross-member known from European Patent application EP-A-0 733 501 has an open U-shaped cross-section. The choice of an open section does not allow to achieve particularly high values of torsional stiffness and makes therefore the cross-member not suitable for those application requiring a high torsional stiffness. Furthermore, the arched shape of the cross-member does not allow to add a torsion bar to increase the torsional stiffness of the cross-member.

European Patent application EP-A-1 080 954 discloses a cross-member for a rear twist-beam axle suspension for a motor vehicle which is obtained by cold-forming of a steel tube. The cross-member extends horizontally and includes a middle portion having a double-wall substantially U-shaped cross-section, a pair of end portions having a circular cross-section corresponding to that of the steel tube from which the cross-member is obtained, and a pair of intermediate portions which join the middle portion with the respective end portions and have a cross-section whose shape varies continuously from a circular one at the transversely outer end to a U-like one at the transversely inner end.

It is an object of the present invention to provide a bowed cross-member for a rear twist-beam axle suspension for a motor vehicle which has a high mechanical strength, which provide the designer with a wide freedom in the positioning of the shear centre of the middle cross-section, which allows the use of the cross-member also in those applications in which the available space is reduced by the presence not only of the drive shaft but also of other components (for instance of the tube connecting the fuel filler neck to the tank).

### SUMMARY OF INVENTION

The present invention overcomes the disadvantages in the related art in a cross-member for a motor-vehicle twist-beam axle suspension. The cross-member includes a single piece of steel that defines a closed cross-section and integrally forms a middle section, a pair of end sections, and a pair of joining sections. The middle section has a center axis extending along a curvilinear path lying in a first plane and a squashed portion extending in a second plane inclined to the first plane. The end sections are adapted to be securely connected to respective trailing arms of the twist-beam axle suspension. Each of the joining sections is interposed between the middle section and the respective end section and defines an opposite concavity with respect to the middle section.

The present invention overcomes the disadvantages in the related art also in a twist-beam axle suspension for a motor vehicle that includes the cross-member and a pair of trailing arms to which the respective end sections are securely connected.

The present invention overcomes the disadvantages in the related art also in a method for production of a cross-member for a motor-vehicle twist-beam axle suspension. The method includes the steps of: cutting a substantially tubular straight piece of steel to a desired length; shaping a middle section of the piece in a first plane such that the middle section defines an outline extending along a curvilinear path lying in a first plane and is joined to a pair of end sections of the piece through a pair of joining sections each of which defines an opposite concavity with respect to that of the middle section; rotating the piece by a given angle; and squashing at least the middle section of the piece in a second plane inclined by the given angle to the first plane.

The end portions can be horizontal straight portions. The cross-member can be obtained from a tube which is suitably squashed on at least part of the arched middle portion, whereby the shape of its middle cross-section is such as to provide the required inertial characteristics.

By virtue of the arched middle portion, the cross-member can be used in rear twist-beam axle suspensions for four- or rear-wheel drive motor vehicles without interfering with the drive shaft. At the same time, by virtue of the horizontal straight end portions the cross-member on the one hand has less problems of space availability than the prior art discussed above and on the other hand has joining edges with the trailing arms which have a more regular shape than the prior art discussed above, whereby the above-mentioned problems due to the generation of stress peaks do not occur. Moreover, by virtue of the use of a squashed tube a middle cross-section is obtained which on the one hand is closed, and is therefore able to provide high values of torsional stiffness even without a torsion bar (which could not even be used due to the bowed shape of the cross-member), and on the other hand can be suitably shaped to locate the shear centre in the desired position in view of the kinematic and elasto-kinematic requirements of the suspension.

According to another advantageous feature of the invention, the orientation of the middle plane of the squashing in the arched middle portion of the cross-member (hereinafter simply referred to as squashing plane) can be set independently of the orientation of the middle plane on which the curvilinear axis of the cross-member (hereinafter simply referred to as camber plane) extends. The squashing plane (the orientation of which is linked to the position of the shear centre of the middle cross-section, and hence to the kinematic and elasto-kinematic performances of the suspension) and the camber plane (the orientation of which is linked to the size constraints the cross-member must comply with) must not therefore coincide with each other, but can also be inclined to each other. The designer of the suspension has therefore a wide freedom in looking for the best compromise among the different requirements, both in terms of layout and in terms of kinematic and elasto-kinematic performances of the suspension.

According to another feature of the invention, the end portions of the cross-member intended to be securely connected to the trailing arms of the twist-beam axle have an enlarged cross-section, that is to say, a cross-section of larger perimeter than that of the cross-section of the middle portion of the cross-member. The amount of the increase in the perimeter of the end portions with respect to the middle portion varies depending on the specific application, naturally within the limits linked to the ability of the material of the cross-member to absorb the deformation. The resulting increase in the inertial characteristics of the joining area with the trailing arms leads to an increase in the mechanical strength and hence to the possibility to transmit a greater torsion moment, as well as to an increase in the stiffness of the twist-beam axle under lateral loads, and hence to an improvement of the handling performances of the vehicle.

Other objects, features, and advantages of the present invention will be readily appreciated as the same becomes better understood while reading the subsequent description taken in conjunction with the accompanying drawings.

### BRIEF DESCRIPTION OF EACH FIGURE OF DRAWING OF INVENTION

FIG. 1 is a perspective view of a twist-beam axle for a rear suspension of a motor vehicle having a cross-member according to an embodiment of the present invention;

FIG. 2 is a perspective view of the cross-member of the twist-beam axle of FIG. 1;

FIG. 3 is a front elevation view of the cross-member of the twist-beam axle of FIG. 1;

FIG. 4 is a side view of the cross-member of the twist-beam axle of FIG. 1; and

FIG. 5 shows the middle cross-section of the cross-member of the twist-beam axle of FIG. 1.

### DETAILED DESCRIPTION OF EMBODIMENTS OF INVENTION

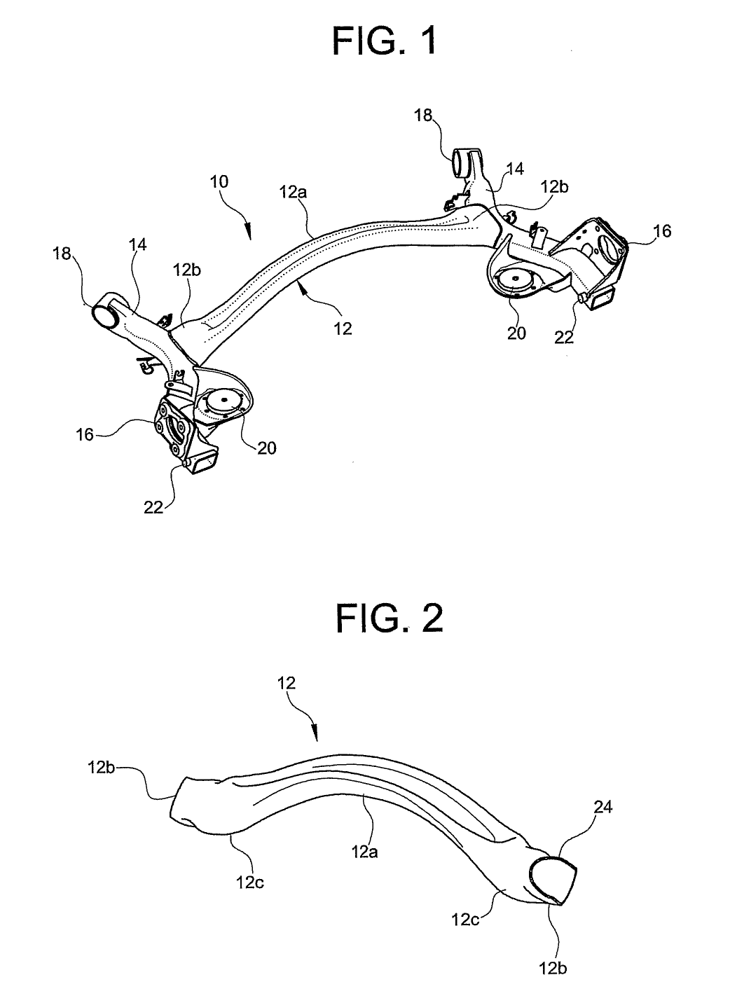

With reference first to FIG. 1, a twist-beam axle for a motor-vehicle suspension, particularly for a rear suspension, is generally indicated 10 and basically comprises a bowed cross-member 12 and a pair of trailing arms 14 securely connected each to a respective side end of the cross-member 12. The trailing arms 14 carry respective wheel-carrying members 16, respective bushing seats 18 for articulated connection of the twist-beam axle 10 to the vehicle body (not shown), respective plates 20 for support of the springs (not shown), as well as respective attachment members 22 for the shock-absorbers (also not shown).

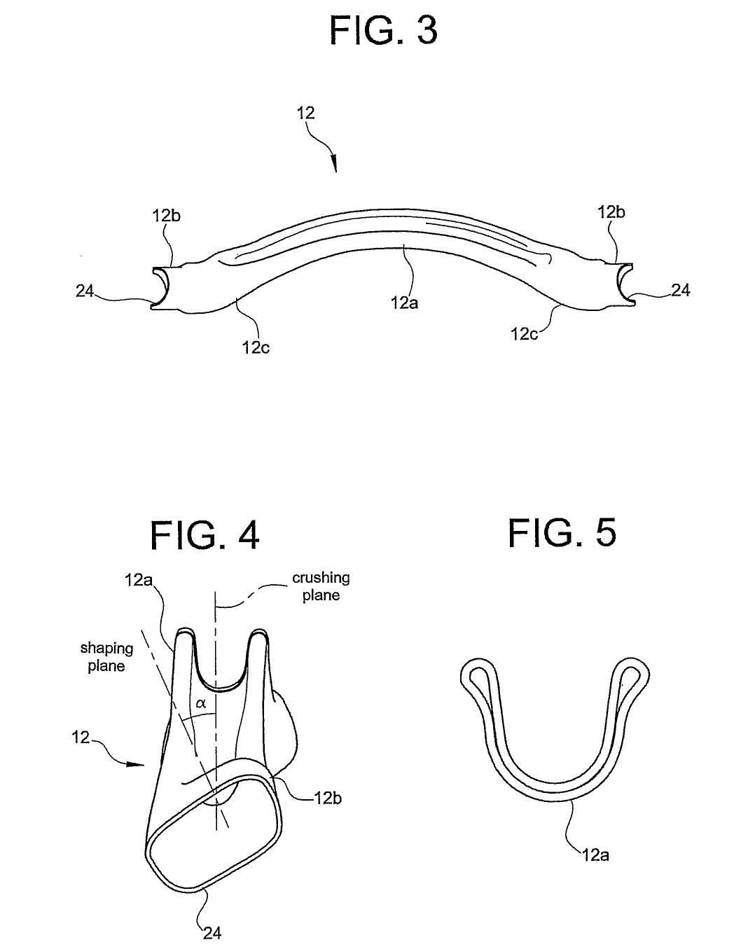

The cross-member 12 includes a single tube of steel, such as manganese-boron steel (for instance, the 20MnB5 steel), or alternatively of low-alloy high-strength steel (cold- or hot-rolled), of multi-phase high-strength steel (cold- or hot-rolled), of two-phase high-strength steel (for instance, the DP600 steel), of ferritic-bainitic high-strength steel or again of high-alloy chromium stainless steel. With reference now to FIGS. 2 to 4 as well, the cross-member 12 comprises integrally a middle portion 12a, a pair of transversely opposite end portions 12b for connection of the cross-member with the trailing arms 14, and a pair of joining portions 12c which join each a respective end portion 12b with the middle portion 12a.

The middle portion 12a of the cross-member 12 has an arched shape, that is to say, its axis extends not along a straight line but along a curved arc-shaped line having a concavity facing downwards, and is therefore located at a greater height than the end portions 12b. The camber of the cross-member 12, that is to say, the vertical distance between the middle portion 12a and the end portions 12b, may take significantly high values, for example, higher than 100 mm. The cross-member 12 can thus be used in a rear twist-beam axle suspension for a rear- of four-wheel drive motor vehicle, since the drive shaft of the motor vehicle can pass underneath the middle portion 12a of the cross-member without interfering with it. The middle portion 12a has a closed cross-section with a suitable shape, for instance with a C-, U-, V-, -like shape, or again with a shape having squashed lobes, which is obtained by squashing of the steel tube forming the cross-member. A particular example of middle cross-section of the cross-member is shown in FIG. 5. As already stated in the introductory part of the description, the use of a closed cross-section makes it possible to achieve high values of torsional stiffness without having to resort to a torsion bar.

The end portions 12b of the cross-member 12 can be straight portions which extend in a horizontal plane, i.e., substantially in the same plane as the trailing arms 14. Accordingly, the end portions 12a have each a joining edge 24 for welded connection with the respective trailing arm 14 which extends rather smoothly and leads therefore to a correspondingly smooth stress distribution, without such high peaks as to cause structural problems. As already stated in the introductory part of the description, the use of horizontal straight end portions also allows to reduce the size problems of the cross-member.

According to an embodiment, the end portions 12b of the cross-member 12 have a larger perimeter than the perimeter of the steel tube from which the cross-member 12 is obtained, i.e., than the perimeter of the middle portion 12a. The amount of increase in the perimeter of the cross-section of the end portions 12b with respect to the middle portion 12a varies depending on the specific application, remaining naturally within the limits due to the ability of the material of the cross-member to absorb the deformation. The resulting increase in the inertial characteristics of the joining area with the trailing arms leads to an increase in the mechanical strength and hence to the possibility to transmit a greater torsional moment, as well as to an increase in the stiffness of the twist-beam axle under lateral loads, and hence to an improvement of the handling performances of the vehicle.

The joining portions 12c of the cross-member 12 are arched portions the concavity of which faces towards the opposite side (upwards) with respect to the middle portion 12a. The cross-member 12 has therefore a generally curved outline with a double change of concavity in the zones between the joining portions 12c and the middle portion 12a.

The cross-member 12 is obtained by shaping and squashing a steel tube. More specifically, the first operation provides the cross-member with the required bowed outline, while the second operation provides the cross-member, particularly the middle portion thereof, with the required cross-section. These two operations are carried out by either cold- or hot-deformation of the steel tube by means of a special tool, that is to say, a shaping tool and a curving tool, respectively, which is moved in a given direction, typically a vertical direction. According to an advantageous feature of the invention, the orientation of the shaping plane and the orientation of the camber plane can be chosen independently of each other, so as to allow the designer of the suspension to choose the best compromise among the different requirements, both in terms of layout and in terms of kinematic and elasto-kinematic performances of the suspension. Such a possibility is provided by the fact that the method of production of the cross-member provides, between the shaping operation and the curving operation, the possibility to rotate the work-piece by an angle α equal to the desired angle of inclination between the shaping plane and the camber plane. This angle can be clearly observed in the side view of FIG. 4.

The method of production of the cross-member according to the invention basically comprises the following steps:
a) cutting a steel tube of proper diameter to the desired length;
b) shaping the tube so as to provide it with the required curved outline;
c) rotating the shaped tube, if necessary, to obtain a given angle of inclination between the shaping plane and the squashing plane;
d) squashing the tube, particularly the arched middle portion thereof, to provide it with a cross-section having the required shape;
e) leaving the tube to recover;
f) enlarging and calibrating, if necessary, the end portions of the tube to such an extent that they have a cross-section with a larger perimeter than that of the cross-section of the tube;
g) thermally treating the tube;
h) calibrating the tube; and
i) definitively cutting the tube by means of a hydraulic or mechanical cutting tool or by means of a laser or plasma cutting apparatus.

The order in which the various steps listed above are carried out may be different from the one disclosed above, for instance the enlargement of the end portions of the cross-member may be carried out before providing the cross-member with the required arched shape, i.e., before the shaping step referred to above as step b). Some steps may even be omitted, in case they are not necessary.

The invention has been described in an illustrative manner. It is to be understood that the terminology that has been used is intended to be in the nature of words of description rather than of limitation. Many modifications and variations of the invention are possible in light of the above teachings. Therefore, within the scope of the appended claims, the invention may be practiced other than as specifically described and shown.

What is claimed is:

1. (canceled)

2. (canceled)

3. (canceled)

4. (canceled)

5. (canceled)

6. (canceled)

7. (canceled)

8. (canceled)

9. A cross-member for a motor-vehicle twist-beam axle suspension, said cross-member comprising:
a single piece of steel that defines a closed cross-section and integrally forms:
a middle section having a center axis extending along a curvilinear path lying in a first plane and a squashed portion extending in a second plane inclined to said first plane;
a pair of end sections adapted to be securely connected to respective trailing arms of said twist-beam axle suspension; and
a pair of joining sections each of which is interposed between said middle section and respective said end section and defines an opposite concavity with respect to said middle section.

10. A cross-member as set forth in claim 9, wherein said end sections include straight sections.

11. A cross-member as set forth in claim 9, wherein said piece of steel is made of any of manganese-boron steel, cold- or hot-rolled low-alloy high-strength steel, cold- or hot-rolled multi-phase high-strength steel, two-phase high-strength steel, ferritic-bainitic high-strength steel, and high-alloy chromium stainless steel.

12. A cross-member as set forth in claim 9, wherein said end sections define a cross-section with a larger perimeter than that of a cross-section defined by said middle section.

13. A cross-member as set forth in claim 9, wherein said twist-beam axle suspension includes a rear suspension.

14. A twist-beam axle suspension for a motor vehicle comprising:
a cross-member including a single piece of steel that defines a closed cross-section and integrally forms:
a middle section defining a centre axis extending along a curvilinear path lying in a first plane and having a squashed portion extending in a second plane inclined to said first plane;
a pair of end sections; and
a pair of joining sections each of which is interposed between said middle section and respective said end section and defines an opposite concavity with respect to said middle section; and
a pair of trailing arms to which respective said end sections are securely connected.

15. A twist-beam axle suspension as set forth in claim 14, wherein said trailing arms define respective center axes that extend in a same plane and said end sections of said cross-member define respective center axes that extend in said same plane.

16. A twist-beam axle suspension as set forth in claim 14, wherein said twist-beam axle suspension includes a rear suspension.

17. A method for production of a cross-member for a motor-vehicle twist-beam axle suspension, said method comprising the steps of:
cutting a substantially tubular straight piece of steel to a desired length;
shaping a middle section of said piece in a first plane such that said middle section defines an outline extending along a curvilinear path lying in a first plane and is joined to a pair of end sections of said piece through a pair of joining sections each of which defines an opposite concavity with respect to that of said middle section;
rotating said piece by a given angle; and
squashing at least said middle section of said piece in a second plane inclined by said given angle to said first plane.

18. A method for production of a cross-member as set forth in claim 17, wherein said method further includes the step of enlarging each of said end sections of said piece such that a cross-section of said end section defines a larger perimeter than that defined by a cross-section of said middle section.

19. A method for production of a cross-member as set forth in claim 17, wherein said twist-beam axle suspension includes a rear suspension.
